(19) United States
(12) Patent Application Publication
(10) Pub. No.: US 2020/0342725 A1
(43) Pub. Date: Oct. 29, 2020

(54) METHOD AND SYSTEM FOR DETECTING MOTION

(71) Applicant: Carrier Corporation, Palm Beach Gardens, FL (US)

(72) Inventors: Tomasz Cieloch, Juszkowo (PL); Tomasz Lisewski, Gdansk (PL)

(21) Appl. No.: 16/854,229

(22) Filed: Apr. 21, 2020

(30) Foreign Application Priority Data
Apr. 24, 2019 (EP) 19170955.9

(51) Int. Cl. G08B 13/00; G08B 21/22; G08B 29/18

(52) U.S. Cl. CPC G08B 13/00; G08B 29/185; G08B 21/22

(57) ABSTRACT

A method for detecting motion is provided. The method includes: detecting a motion of a body in order to generate motion data; detecting a location of an allowed movable body in order to generate location data; and determining whether the motion of the body is a motion of the allowed movable body based on at least the motion data and the location data. A security system for verifying a detected motion is also provided. The system includes: a motion detection system; a location detection system; and a processing unit configured to determine whether motion detected by the motion detection system is a motion of the allowed movable body. The system may be for performing the method of detecting motion.

This application claims priority to European Patent Application No. 19170955.9, filed Apr. 24, 2019, and all the benefits accruing therefrom under 35 U.S.C. § 119, the contents of which in its entirety are herein incorporated by reference.

### BACKGROUND

The present invention relates to a method for detecting motion and a security system for verifying a detected motion. The method and system may determine whether a detected motion is that of an allowed movable body. The present invention may be particularly useful for, but not limited to, alarm systems for households with pets as the method and system may distinguish between the motion of an allowed pet in the household and that of an intruder.

It is desirable to reduce the rate of false alarms in security systems. One common example of a false alarm is the triggering of a home alarm system by the motion of a pet.

It is, for example, particularly important to limit false alarms in the systems of premises which are registered with local law enforcement, where law enforcement will attend the premises when the alarm is triggered. If false alarms are too frequent, the premises may be struck off the register and law enforcement will no longer attend the premises when the alarm is triggered.

Many conventional security systems use motion detectors that detect passive infrared (PIR) signals generated as body heat (infrared energy). By “passive” it is meant that the sensors of the systems detect signals produced by other bodies but do not emit these signals themselves. Passive infrared sensors are widely used sensors in home security systems. The sensor of a typical system can detect changes in heat and thus movement of heat sources in the region which it monitors, dividing this region into a protective “grid.” If a moving object is present in too many grid zones and/or the infrared energy levels change rapidly across the grid zones, the sensors are tripped, thus triggering the alarm.

Other security systems utilize active signals such as radar (e.g. microwaves) or ultrasound. By “active” it is meant that sensors emit signals and detect a corresponding reflected signal. For example, sensors may emit radio or microwave pulses and measure the reflection off a moving object in order to detect a change in its location and thus a movement of the object. Sensors can also emit infrared signals from an LED following a similar principle.

Typical alarm systems, such as household alarms systems, are designed to detect a human who is an intruder. However, pets can still trigger these systems, particularly large pets or those that are very active and more prone to move around inside the household. For example, cats or dogs jumping onto furniture may trigger an alarm system. Furthermore, some conventional systems cannot distinguish between a smaller pet that is close to a motion detection sensor and a larger human that is far away from the sensor (i.e. the signal amplitudes of both are equal). This is particularly troublesome in PIR systems.

Conventional methods of dealing with the motion of pets and the associated risk of false alarms include lowering the sensitivity of sensors, or blocking the sensors altogether in the lower part of the region that they monitor. In this way, pets in the lower region, such as those walking on the floor of a household do not trigger the alarm system.

Alternative methods of overcoming the problem of false alarms from pets include dividing of the monitored space into two parts: an upper part and a lower part, and requiring that signals indicating motion in both parts be detected in order to trigger the alarm. In this way, a human walking through the monitored space would be present in both the upper and lower part, thus triggering the alarm, but a pet present in only one part (e.g. a dog walking in the lower part) would not.

One problem faced with both of these methods is that the triggering of the alarm system may be avoided by an intruder attempting to emulate the motion of a pet (e.g. by crawling), and thus being present only in the less sensitive/blocked region or only the lower part of the monitored region.

The inventors of the present invention have therefore realised that there is a need in the art for a method and security system that can minimise false alarm triggers (e.g. from pets) whilst not lowering the sensitivity or effectiveness of the system.

### SUMMARY

In a first aspect, the present invention provides a method for detecting motion, the method comprising: detecting a motion of a body in order to generate motion data; detecting a location of an allowed movable body in order to generate location data; and determining whether the motion of the body is a motion of the allowed movable body based on at least the motion data and the location data.

By detecting the location of a predetermined allowed movable body (e.g. a pet) the system may be able to verify whether the detected motion is the motion of the allowed movable body. This allows a determination of whether the detected motion is of an unallowed movable body (such as an intruder).

If it is determined that the detected motion of a body is not a motion of the allowed movable body, the system may further comprise a determination that the detected motion is that of an unallowed movable body, such as an intruder. An unallowed movable body and/or intruder according to any aspect of the present invention may be any movable body prohibited from being in a particular area and/or not a predetermined allowed movable body, such as an unexpected movable body. For example, an unallowed movable body, e.g. intruder, may be a person such as a trespasser or burglar. Alternatively, an unallowed movable body could be a vehicle, animal, or any other prohibited or unexpected moving object.

An allowed movable body according to any aspect of the present invention may be a person, animal, vehicle, or any other object that is permitted to be in a particular area. The allowed movable body or bodies may be predetermined. For example, in the case of a household, an allowed movable body may be a pet such as a cat or a dog, or an appliance such as a robotic vacuum or similar. An allowed movable body could also be a child or adult, particularly a child or adult that lives in the household.

There may be more than one allowed movable body, e.g. a plurality of pets in a household. The method may comprise detecting a location of each allowed movable body and generating location data for each allowed movable body. The method may comprise determining whether the motion of the body is a motion of any of the allowed movable bodies.

Any aspect of the present invention may be used as part of a security method and/or security system. Thus the method may be a security method and may be performed using a security system. The method may be a method for detecting motion for security purposes.

Any aspect of the present invention may be used in a predetermined space. The method may be for detecting location within a predetermined space. The steps of detecting of motion and/or location may be within a predetermined space. The predetermined space may be a building or property such as a house, workplace or other protected/secured premises. The predetermined space may be divided into a number of rooms.

The detection of a motion of a body may be carried out by a motion detection system. The motion detection system may generate motion data when motion is detected. The motion detection system may detect signals indicating a motion of a body and generate motion data based on these signals. The motion detection system may receive signals from a body in order to detect a motion. These signals may include any one or a combination of: infrared, radar and ultrasound signals. The motion detection system may comprise infrared, radar and/or ultrasound detectors.

The detected signals may be signals received passively, such as infrared. In the case of infrared signals, these signals may be emitted by the body naturally, for example the body heat of a pet or human.

Alternatively, these signals may be signals received actively (i.e. after an emission by the detector system itself). For example, in the case of infrared, radar and/or ultrasound, signals may be emitted by the motion detection system and reflected by the body before being received back at the motion detection system and analysed in order to detect a movement of the body and generate motion data. Such signals work in a similar manner to radar to detect a movement.

The skilled person will appreciate that any known motion detection system may be utilised in the present invention to perform the motion detection.

Motion data may be generated by the motion detection system based upon the signals that it (passively or actively) receives which indicate motion. The motion data may comprise characteristic parameters of the motion. For example, the motion data may comprise any one or a combination of the following characteristic parameters of the signal that the motion detection system detects: frequency, phase shift, time delay, maximum value, minimum value, average value, amplitude spectrum components, phase spectrum components, intensity and duration.

Alternatively, or in addition to the characteristic parameters, the motion data may also comprise any one or a combination of the following: indication of a movement of a body; location of a movement of a body, optionally wherein the location may be a particular space or an exact location; a direction and/or speed of a movement of a body the number of movements detected in a predetermined time frame and/or location; the number of movements detected at any one time; or an absence of a detected signal indicating a motion of a body.

The detecting of the location of an allowed movable body may be carried out by a location detection system.

The location detection system may comprise one or more location indicators, such as a tag, which are each to be associated with, e.g. attached to, the one or more allowable movable bodies.

The method may comprise associating a location indicator with each allowed movable body. For example, the location indicator may be attached to or embedded within each allowed movable body. For example, the location indicator may be a tag that is attached to the collar of a pet or a tag/chip that is embedded within the pet.

The location detection system may comprise one or more location detection sensors.

The location indicator may only indicate the location of the movable body when requested. This may reduce the power requirements of the location indicator associated with the allowed movable body. For example, when motion is detected, a location request signal may be sent (e.g. by request of a processing unit) to the location indicator. Upon receiving a location request signal, the location indicator may emit a signal that can be used to determine the position of the location indicator, and hence the associated allowed movable body.

The detecting of the location of the allowed movable body may comprise sending a location request signal to the location indicator, i.e. tag, associated with allowed movable body. The location request signal may only be sent after a motion of a body has been detected, e.g. by the motion detection system. The sending of a location request signal may occur after motion data has been generated. The location request signal may be sent by the location detection system, optionally a location request signal may be sent by each of a number of location detection sensors of the location detection system.

The, or each, location request signal may be received by the location indicator associated with the allowed movable body, e.g. a tag attached to the allowed movable body, and, in response to the request, the location indicator may transmit a response signal, e.g. a location signal. The location detection system may receive the location signal transmitted by the location indicator. The location signal may be used to generate the location data. The location data may comprise the time between sending a location request signal and receiving a location signal at one or each location sensors. The time between sending a location request signal and receiving a location signal at one or each location sensors may be used to determining the location of the location indicator and hence the allowed movable body with which the location indicator is associated.

If a location request signal is sent by each of a plurality of location sensors, each location sensor may receive a corresponding location signal in response to its location request signal (i.e. the location request signals and location signals are paired and each pair is associated with one location sensor).

The location detector system may comprise three location sensors. Each location sensor may have an associated pair of location request signals and location signals (assuming the location indicator is within range to receive the location request signal).

The location indicator/tag may be any label, marker, badge, identifier, chip or similar. The location indicator may be removably attached to the allowed movable body.

The location request signal and location signal may be radio frequency, infrared or ultrasound signals. For example the location request signal and/or the location signal may be a radio frequency pulse. The location indictor may only emit a location signal in the form of a radio frequency pulse when a radio frequency pulse is received at the location indicator. The time between sending a location request signal from a location sensor to the location indicator and receiving a location signal from the location indicator at the location sensor may be referred to as a time delay. This time delay (optionally with time delay(s) measured at one or more other location sensors) may be used to determine the location of the allowed movable body.

This location signal may contain location data, and/or location data may be generated based on this signal.

For example, after the location signal is received at a location sensor, the length of time between the location request signal being sent by the location sensor and the location signal being received by the location sensor (i.e. a time delay) may be used to calculate the distance from the location sensor to the allowed movable body (this may be calculated based on the origin of the positioning location signal, the location at which the location signal is received and the known speed of the signals). The location data may include an angle of the allowed body relative to a location sensor and/or an exact location (e.g. a GPS location or geofence location) of the allowed movable body.

Alternatively, the distance between the location sensor and the allowed movable body may be determined by the strength of the location signal (if the signal strength decays over distance following a known function, for example).

The location data may be used to trilaterate and/or triangulate the location of the allowed movable body.

The location data may be generated based on a number of signals. For example, the location of the allowed movable body may be identified based on three location signals and the location detection system may comprise at least three location detectors that each receives a location signal. In this way, each location signal can indicate the distance of the location indicator (which is associated with an allowed movable body) to a different location sensor and the three distances may be used to determine, e.g. triangulate or trilaterate, the exact location of the allowed movable body.

Location data may comprise any one or a combination of the following: a distance to allowed movable body; a time delay between the sending of a location request signal and receiving of a location signal; the location of the allowed movable body; a confirmation of whether the allowed movable body is present in the predetermined space; an absence of a received location signal.

The determination of whether the motion of the body (i.e. the detected motion) is a motion of the allowed movable body based on at least the motion data and the location data may comprise a determination of whether the allowed movable body is in a location where it could have produced the detected motion (i.e. if a detected signal indicating motion could have originated from the allowed movable body).

The determination of whether the motion of the body (i.e. the detected motion) is a motion of the allowed movable body based on at least the motion data and the location data may comprise analysis of the characteristic parameters of the motion and the location data to determine whether the detected motion was created by the allowed movable body.

For example, the analysis may comprise one or more or all of determining whether the sensed motion is in the same room as the allowed movable body, whether the strength of the motion signal correlates with the distance between the allowed movable body and the triggered motion detector, whether the other characteristics parameters (e.g. those that indicate the size of the moving body) correlate with known information about the allowed movable body.

The method may comprise (and/or processing unit may be configured to perform the method that comprises) a number of independent verification steps each comprising a different method to verify whether the detected motion was caused by the allowed movable body.

For example, the determination of whether the motion of the body is a motion of the allowed movable body based on at least the motion data and the location data may comprise determining if the allowed movable body is in the same room as the detected motion of a body. If the detected motion of a body is in a different room to the (or any) allowed movable body then it may be determined that it could not have been produced by the (or any) allowed movable body and the detected motion of a body may be determined to be that of an intruder. If the allowed movable body is not present within the predetermined space in which the method is carried out (for example if no location signal is received), this may indicate that the motion is that of an unallowed movable body, i.e. an intruder.

The determination of whether the motion of the body (i.e. the detected motion) is a motion of the allowed movable body based on the location data and motion data may be based in part on the amplitude of the signal detected by the motion detection system indicating motion of a body and a calculated distance of the allowed movable body to the motion detector. For example, if the amplitude of the motion signal is large (e.g. possibly indicating a human at a mid-range distance from the location sensor), the allowed movable body is known to be smaller in size than a human, and the location data indicates that the (or any) allowed movable body is far away from the motion detection sensor, then a determination may be reached that the motion signal could not have been generated by the (or any) allowed movable body.

The above described method may be carried out with any number of allowed movable bodies, with the location being detected and location data being generated for each allowed movable body. Thus, the above disclosure should be understood to be equally applicable in a method and system with a plurality of allowed movable bodies.

The method may further comprise triggering an alarm if a determination is reached that the detected motion of a body is not that of the (or any) allowed movable body. The method may further comprise determining that an unallowed movable body, e.g. an intruder, has been detected because the motion of a body is not that of any allowed movable body, i.e. it is that of an intruder.

In a second aspect, the present invention provides a security system for verifying a detected motion, the security system comprising: a motion detection system configured to detect a motion of a body and generate motion data based on the motion of the body; a location detection system configured to detect a location of an allowed movable body and generate location data based on the location of the allowed movable body; and a processing unit configured to receive the motion data and the location data and determine whether the motion detected by the motion detection system is a motion of the allowed movable body.

The system according to the second aspect (optionally including one or more or all of the below described optional features) may be configured to perform the method (optionally including one or more or all of the optional features) of the first aspect. The method of the first aspect (optionally including one or more or all of the optional features) may be performed using the system of the second aspect (optionally including one or more or all of the below described optional features).

The system may be used in a predetermined space. The system may be for verifying detected motion within a predetermined space. The motion detection system may be for detecting motion within a predetermined space. The location detection system may be for detecting the location of an allowed movable body within a predetermined space. The predetermined space may be a building or property such as a house, workplace or other protected/secured premises. The predetermined space may comprise a plurality of rooms.

The motion detection system may comprise a one or more motion detectors. The system may comprise a plurality of motion detectors. The system may comprise at least one motion detector in each room of the predetermined space that is monitored by the motion detection system.

The motion detector(s) may be for generating motion data when motion is detected. The motion detector(s) may be configured to detect signals that indicate a motion of a body and the motion detection system may be configured to generate motion data based on these signals. The motion detectors may be configured to receive signals from a body in order to detect a motion. These signals may include any one or a combination of: infrared, radar and ultrasound signals. Thus the motion detectors may be infrared, radar and/or ultrasound detector (i.e. comprise infrared, radar and/or ultrasound sensors).

The detector(s) may be configured to receive signals passively, such as infrared signals. In the case of infrared signals, these signals may be emitted by the body naturally, for example in the case of a pet or human. Alternatively, the detector(s) may be configured to receive signals actively. For example, in the case of infrared, radar and/or ultrasound, signals the motion detection system may be configured to emit these signals and the detector(s) may be configured to receive reflected signals and detect a movement of a body and generate motion data based on the received signals.

The skilled person will appreciate that any known motion detection system and motion detectors may be utilised in the system of the present invention.

The motion detection system may be configured to generate motion data based upon the signals that it is configured to receive at the motion detectors which indicate motion. The system may be configured to generate motion data that comprises an indication of one or more characteristic parameters of the motion.

For example, the motion data may comprise any one or a combination of the following characteristic parameters of the signal that the motion detection system detects: frequency, phase shift, time delay, maximum value, minimum value, average value, amplitude spectrum components, phase spectrum components, intensity and duration.

Alternatively, or in addition to the characteristic parameters, the motion data may also comprise any one or a combination of the following: indication of a movement of a body; location of a movement of a body, optionally wherein the location may be a particular space or an exact location; a direction and/or speed of a movement of a body the number of movements detected in a predetermined time frame and/or location; the number of movements detected at any one time; or an absence of a detected signal indicating a motion of a body.

The system may be configured to send this data to the processing unit. The processing unit may also be referred to as a central unit. The data may be transferred via a wired or wireless connection.

The processing unit may be configured to: instruct the system so that each location sensor sends a location request signal when motion is detected, collect motion data (including the characteristic parameters) and location data (optionally including time delay measurements), calculate position of the one or more allowed movable bodies (e.g. based on time delay measurements), and/or classify whether the detected motion has been created by one or more of the allowed movable bodies or not. The step of classifying whether the motion has been created by one or more of the allowed movable bodies or not may be based on the characteristic parameters of the motion data and the calculated position of the one or more allowed movable bodies.

The location detection system may comprise one or more location detection sensors. For example, the location detection system may comprise three location detection sensors. The system may be configured so that detection of a location of an allowed movable body is carried out in one or more of the ways discussed in relation to the first aspect, including the use of location request signals and location signals.

The location detection system may comprise one or more location indicators, such as a tag. The location indicators may each be for association with, e.g. attached to, an allowed movable body.

The one or more location indicators may each be associated with, e.g. attached to, or embedded within, an allowed movable body.

The location indicators may each be removably attached to an allowed movable body. This location indicator may be used in any way described relation to the first aspect. The location indicator may be any tag, label, marker, badge, chip, identifier or similar.

The location detection system (e.g. one or more or each of the location detectors) may be configured to send a location request to the location indicator associated with each allowed movable body. The system may be configured so that the location request signal is only sent after a motion of a body has been detected by the motion detection system and/or motion data has been generated.

The location indicator(s) may be configured to receive the location request signal(s). The location indicator(s) may be configured to transmit a location signal. This may be in response to receiving a location request signal.

Each location sensor may be configured to receive location signal(s) from the location indicator(s).

The location signal may contain location data, and/or location data may be generated based on this signal. The location data may be any data as discussed in relation to the first aspect and the system may be configured to generate such data in any way as described relation to the first aspect.

The location detectors or location detection system may be configured to send location data to the processing unit. The data may be sent via a wired or wireless link.

The motion detectors and location detectors may be housed in detector units and each detector unit may house both a motion detector and a location detector. In other words, each motion detector may be housed together with a location detector in a common detector unit. There may be a detector unit housing a location detection sensor and a motion detection sensor in each room of a building that is to be monitored by the system.

The processing unit may be connected (e.g. via wired or wireless connection) to both the location detection system and the motion detection system, such that signals and data can be transmitted between each these components. The processing unit may be configured to receive data from the location detection system (e.g. the location sensors) and the motion detection system (e.g. the motion detectors).

The processing unit may comprise a processor and/or memory.

The processing unit may be connected to mains power and may supply power to the location detection system and motion detection system.

The processing unit may receive the motion data and location data as mentioned above and the processing unit may be configured to determine whether or not the motion was triggered by an unallowed movable body, e.g. an intruder, based on the motion data and location data. The processing unit may be configured to process the received data. The processing unit may be for verifying the detected motion. The processing unit may be configured to verify the detected motion by determining whether the motion detected by the motion detection system is a motion of the (or any) allowed movable body, The processing unit may be connected to an alarm (which may or may not be part of the security system). The processing unit may be configured to sound the alarm if the detected motion of a body is not that of an allowed movable body. The system may be referred to as an alarm system.

The determination may be carried out in any of the ways described in relation to the first aspect. Thus, the system may be configured to perform the determination in any of the ways described in relation to the first aspect.

The system may be provided by adapting existing, conventional motion detection and/or alarm systems. For example, a location detection system could be added to a typical system and an existing control/processing unit could be reprogrammed as necessary.

Therefore, in another aspect the present invention may provide a method of adapting an existing (e.g. conventional) motion detection system in order to perform any of the above described methods according to the first aspect and to provide any of the above described systems according the second aspect.

### DRAWING DESCRIPTION

Certain embodiments of the present invention will now be described, by way of example only, with reference to the accompanying drawings, in which:

FIG. 1 is a flow diagram of a method of verifying a motion;

FIG. 2a is a schematic diagram illustrating sending a location request signal;

FIG. 2b is a schematic diagram illustrating receiving a location signal;

FIG. 3 is a schematic diagram of a security system; and

FIG. 4 is a schematic diagram illustrating how the location of an allowed movable body may be determined.

### DETAILED DESCRIPTION

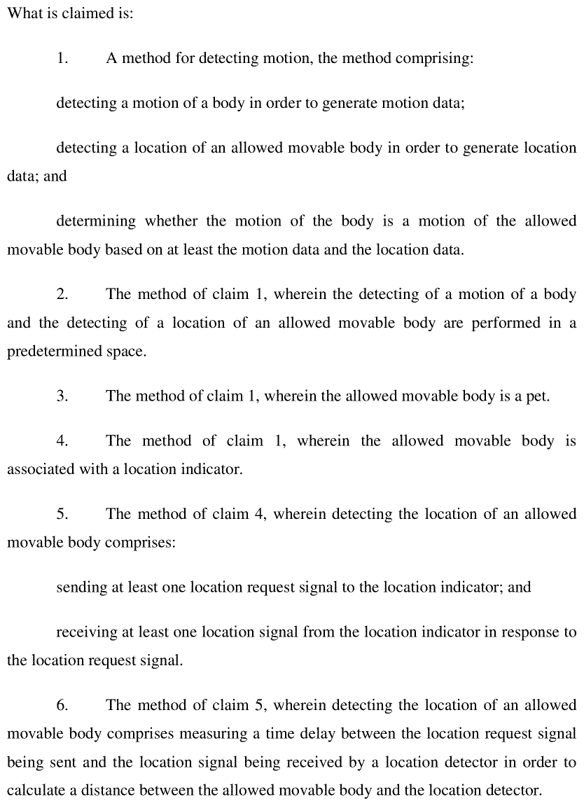

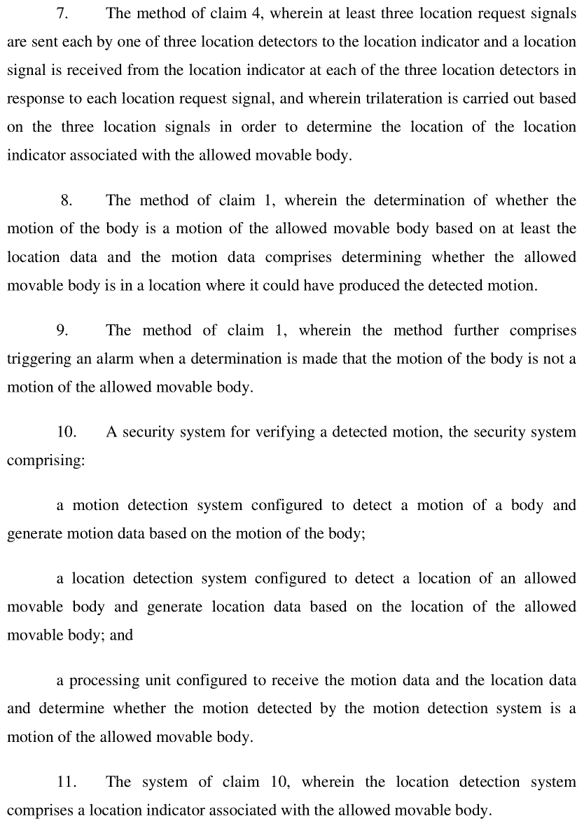

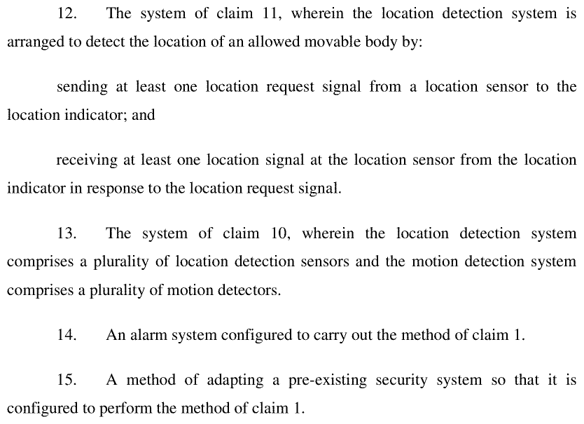

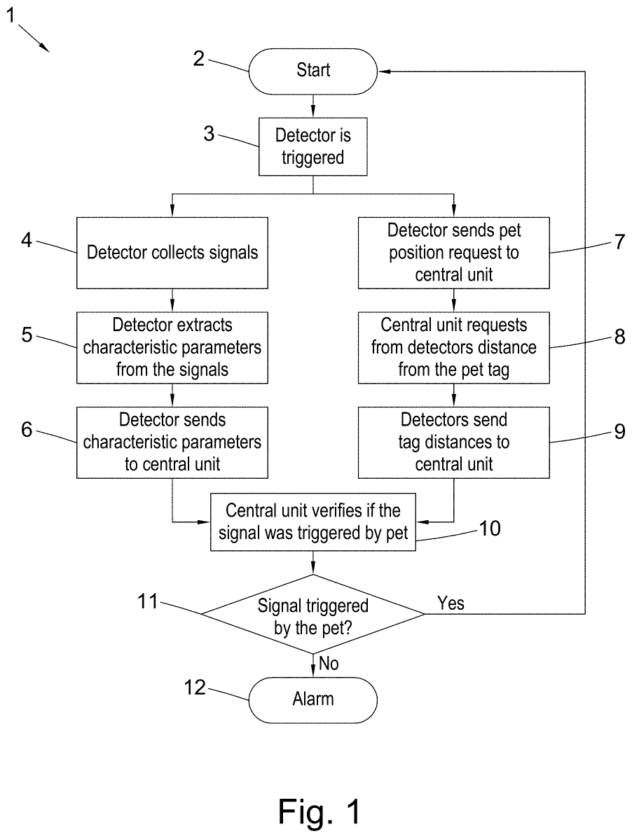

A method 1 for verifying a detected motion in a household with an allowed movable body that is a pet is shown in FIG. 1. Although this example is a household and the movable body is a pet, the invention may be applicable to any space that can be monitored, e.g. for use with any security system, and/or any allowed movable body.

The allowed movable body, in this case a pet, has an associated location indicator, e.g. a tag attached to its collar. The method starts at step 2, where an alarm system is in an operable mode and motion detectors of a motion detection system are monitoring a predetermined region of the household for any signals indicating movement. When a signal indicating movement is detected by any one of the motion detectors the detector is triggered at step 3.

Following the triggering of a motion detector, the method proceeds to step 4, where the motion detector collects the signal(s) indicating motion. For example, this could include a passive infrared signal of the body that is moving. At step 5, the characteristic parameters of this signal are extracted; these characteristic parameters are the generated motion data of the present invention. In the case of a passive infrared signal these could for example include its amplitude, duration and frequency, amongst other parameters. These characteristic parameters are then sent to a central unit (i.e. a processing unit) of the alarm system at step 6.

Following the triggering of the motion detector, the method also proceeds to step 7 (e.g. in parallel to proceeding to step 3 described above), where the system sends a position request to the central unit. At step 8, in response to the position request, the central unit sends an activating signal to the location detection system requesting the location of the pet. The location detection system comprises a number of location sensors, preferably three, and upon receiving the activating signal from the central unit, each of the location sensors sends a location request signal to the tag attached to the pet.

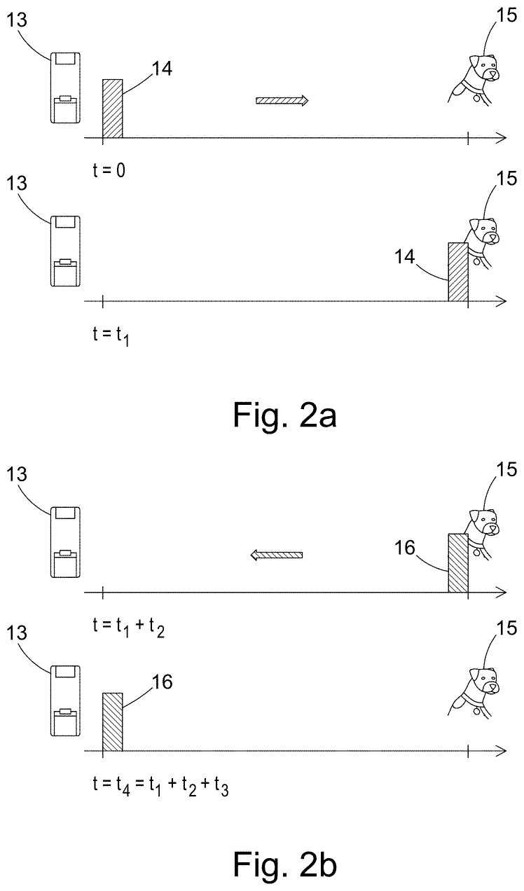

When the tag receives a location request signal from a location sensor it sends a location signal in response back to the location sensor. The location detection system then calculates the distance between the tag and the location sensor based upon the time delay between the location request signal being sent from the location detector and the location signal being detected by the location sensor. This occurs for each of the three location sensors. The distance calculation method is further detailed in FIGS. 2a and 2b.

FIG. 2a schematically illustrates the location detector 13 sending a radio frequency pulse (the location request signal 14) towards the tag 15 and hence also the pet. The time between the location request signal being sent and received by the tag is t1.

FIG. 2b illustrates the pet tag 15 sending a radio frequency pulse (the location signal 16) back towards the detector 13. This location signal 16 is sent from the pet tag 15 after the tag receives the location request signal 14 and after a known added time delay of t2 that takes into account a delay in processing of the location request signal 14 and sending of the location signal 16 by the tag. The location signal 16 is then received back at the location detector; the time between the location signal being sent from the tag and received by the location detector is t3. The total time, t4, between the sending of the location request signal and the receiving of the location signal at the location sensor is the sum of t1, t2 and t3. As both the location request signal and the location signal are radio frequency pulses, and the delay time t2 is known, the distance between the tag and the location detector can be calculated as: (t4−t2)/(2·c), where c is the speed of light (i.e. the speed of radio waves).

This calculation treats any movement of the tag during the delay time t2 as negligible. This calculated distance between the tag and the detector is used to generate location data of the pet.

Turning back to the method shown in FIG. 1, at step 9 the calculated distance (location data) is then sent from the location detection system to the central unit.

At steps 10 and 11, the central unit makes a determination about whether or not the signal indicating a motion of a body originated from the pet. If is determined that the signal originated from the pet, or it is likely that this is the case, the method returns to start 2 and the alarm system, continues monitoring for motion in the predetermined area as normal. If the signal indicating motion could not have originated from the pet then a determination is reached that it must have originated from an intruder and the alarm is triggered at step 12.

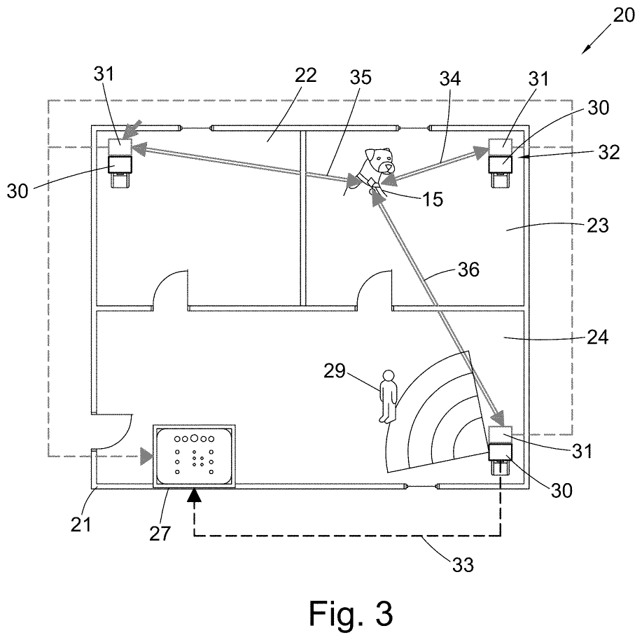

An alarm system 20 which may perform the method described above is shown schematically in FIG. 3. Alarm system 20 is configured to monitor a household 21, which in this case comprises three rooms 22, 23, 24. The alarm system 20 comprises location detection system 25, motion detection system 26 and central unit 27.

A pet with tag 15 is shown in room 23 and an intruder 29 is shown in room 24.

The motion detection system 20 comprises three motion detectors 30, one in each room and is configured to detection any motion of a body in the rooms. The location detection system comprises three location detection sensors 31, one in each room. The motion detectors and the location detectors are part of the same detector units 32.

The intruder 29 triggers the motion detector 30 in room 24 and the motion detector 31 collects and sends motion data 33 to central unit 27. This data can be sent via a wireless or wired link to the central unit 27.

The central unit 27 then sends an activating signal to the location detection system 26 requesting the location of the pet and the location detectors 31 each send location request signals to the tag 15. In response to each location request signal, the tag sends corresponding location signals to the respective location detectors and the distance to each detector (distances 34, 35 and 36 respectively) is calculated in line with the method described above in relation to FIGS. 2a and 2b.

The distances 34, 35, 36 (the location data) to each location sensor are sent via wired or wireless link to the central unit 27 which calculates, e.g. triangulates or trilaterates, the position of the tag (and pet) and makes a determination about whether the motion of the body is a motion of the allowed movable body based on at least the motion data and the location data.

For example, in the case illustrated in FIG. 3, the motion of a body occurred in room 24 and the pet location is determined to be in room 23, therefore it may be determined that the detected motion could not have originated from the pet and so an intruder has been detected. The alarm system would therefore trigger the alarm.

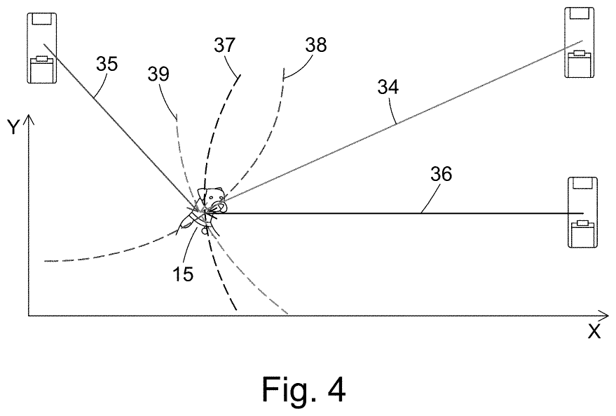

The method of generating location data, specifically the precise location of a pet via trilateration is shown in two dimensions in FIG. 4.

Here, once distances 34, 35 and 36 from respective motion detection sensors 31 have been calculated, arcs 37, 38, 39 can be mapped that correspond to those distances. The point at which these arcs overlap is the exact location of the tag, and thus the allowed movable body (the pet).

The method and system may use any known method and system to detect location and/or any known method and system to detect the location of an allowed movable body.

Whilst the above describes an example with one allowed movable body, there may be a plurality of allowed movable bodies each with an associated location indicator, e.g. tag.

Whilst various aspects of the present invention have been described above with reference to exemplary embodiments, it will be understood by those skilled in the art that various changes may be made and equivalents may be substituted for elements thereof without departing from the scope of the invention as defined by the claims. Therefore, it is intended that the invention not be limited to the particular embodiment(s) and examples disclosed, but that the invention will include all embodiments falling within the scope of the appended claims.

What is claimed is:

1. A method for detecting motion, the method comprising:
detecting a motion of a body in order to generate motion data;
detecting a location of an allowed movable body in order to generate location data; and
determining whether the motion of the body is a motion of the allowed movable body based on at least the motion data and the location data.

2. The method of claim 1, wherein the detecting of a motion of a body and the detecting of a location of an allowed movable body are performed in a predetermined space.

3. The method of claim 1, wherein the allowed movable body is a pet.

4. The method of claim 1, wherein the allowed movable body is associated with a location indicator.

5. The method of claim 4, wherein detecting the location of an allowed movable body comprises:
sending at least one location request signal to the location indicator; and
receiving at least one location signal from the location indicator in response to the location request signal.

6. The method of claim 5, wherein detecting the location of an allowed movable body comprises measuring a time delay between the location request signal being sent and the location signal being received by a location detector in order to calculate a distance between the allowed movable body and the location detector.

7. The method of claim 4, wherein at least three location request signals are sent each by one of three location detectors to the location indicator and a location signal is received from the location indicator at each of the three location detectors in response to each location request signal, and wherein trilateration is carried out based on the three location signals in order to determine the location of the location indicator associated with the allowed movable body.

8. The method of claim 1, wherein the determination of whether the motion of the body is a motion of the allowed movable body based on at least the location data and the motion data comprises determining whether the allowed movable body is in a location where it could have produced the detected motion.

9. The method of claim 1, wherein the method further comprises triggering an alarm when a determination is made that the motion of the body is not a motion of the allowed movable body.

10. A security system for verifying a detected motion, the security system comprising:
a motion detection system configured to detect a motion of a body and generate motion data based on the motion of the body;
a location detection system configured to detect a location of an allowed movable body and generate location data based on the location of the allowed movable body; and
a processing unit configured to receive the motion data and the location data and determine whether the motion detected by the motion detection system is a motion of the allowed movable body.

11. The system of claim 10, wherein the location detection system comprises a location indicator associated with the allowed movable body.

12. The system of claim 11, wherein the location detection system is arranged to detect the location of an allowed movable body by:
sending at least one location request signal from a location sensor to the location indicator; and
receiving at least one location signal at the location sensor from the location indicator in response to the location request signal.

13. The system of claim 10, wherein the location detection system comprises a plurality of location detection sensors and the motion detection system comprises a plurality of motion detectors.

14. An alarm system configured to carry out the method of claim 1.

15. A method of adapting a pre-existing security system so that it is configured to perform the method of claim 1.
